(19) United States
(12) Patent Application Publication
(10) Pub. No.: US 2025/0139476 A1
(43) Pub. Date: May 1, 2025

(54) QUANTUM COMPUTING SYSTEM MODEL TRAINING

(71) Applicant: Fujitsu Limited, Kawasaki-shi, Kanagawa (JP)

(72) Inventor: Hannes LEIPOLD, Newark, CA (US)

(73) Assignee: Fujitsu Limited, Kawasaki-shi, Kanagawa (JP)

(21) Appl. No.: 18/497,929

(22) Filed: Oct. 30, 2023

(51) Int. Cl. G06N 10/20; G06N 10/40

(52) U.S. Cl. CPC G06N 10/20; G06N 10/40

(57) ABSTRACT

A method may include selecting multiple data subsets from a data set and training multiple parameters of a quantum computing system model using the multiple data subsets and a quantum circuit depth using a quantum computer over multiple iterations. The method may include generating a solution for the plurality of data subsets using the quantum computing system model and the quantum computer. The method may also include comparing the solution to a threshold solution. The method may include adjusting the quantum circuit depth in response to the solution of the quantum computing system model not satisfying the threshold solution. The method may additionally include retraining, using the quantum computer, the multiple parameters of the quantum computing system model using the multiple data subsets and adjusted quantum circuit depth.

The present disclosure generally relates to quantum computing system model training.

### BACKGROUND

Quantum computers may use quantum bits (“qubits”) capable of representing information as ones, zeroes, or ones and zeroes simultaneously. Quantum computers may train parameters of quantum computing system models for some types of computations, such as optimization problems, integer factorization, simulation modeling, and/or data analysis, more efficiently and/or more accurately than classical computers. However, existing quantum computers are generally classified as noisy intermediate-scale quantum (NISQ) devices because they only include a limited number of qubits that may be prone to errors in computation due to noise and are consequently typically unable or unsuitable to train parameters of computationally demanding models.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

According to an aspect of an embodiment, a method may include selecting multiple data subsets from a set of data sets and training multiple parameters of a quantum computing system model using the multiple data subsets and a quantum circuit depth using a quantum computer over multiple iterations. The method may include, generating a solution for the data subsets using the quantum computing system model and the quantum computer. The method may also include comparing the solution to a threshold solution. The method may include adjusting the quantum circuit depth in response to the solution of the quantum computing system model not satisfying the threshold solution. The method may additionally include retraining, using the quantum computer, the multiple parameters of the quantum computing system model using the multiple data subsets and adjusted quantum circuit depth.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1 illustrates an example operating environment for training parameters of a quantum computing system model according to one or more embodiments of the present disclosure;

FIG. 2 illustrates an example quantum circuit of a quantum computer according to one or more embodiments of the present disclosure;

FIG. 3 illustrates a flowchart of an example method for training parameters of a quantum computing system model according to one or more embodiments of the present disclosure;

FIG. 4 illustrates a flowchart of another example method for training parameters of a quantum computing system model according to one or more embodiments of the present disclosure; and

FIG. 5 illustrates an example computing system according to one or more embodiments of the present disclosure.

### DETAILED DESCRIPTION

Quantum computers use quantum bits, or “qubits,” that are configured to store values of 0, 1, or a superposition of both 0 and 1. Because qubits are capable of simultaneously storing multiple values, quantum computers are capable of performing calculations more quickly than classical computers that use classical bits storing values of either 0 or 1. Consequently, quantum computers may more efficiently train models related to advanced computations, such as those for optimization problems, and improve computations in various technology fields, such as physics, chemistry, material design, drug discovery, and machine learning.

Quantum computing system models may be used to analyze highly complex data sets using a large number of parameters. For example, training models to solve optimization tasks for large data sets is generally classified as an NP-hard problem, a problem that cannot be solved in polynomial time by a non-deterministic Turing machine. Therefore, such problems may be solved using quantum computing system models on quantum computers. However, quantum computing system models for such problems may suffer from exponentially vanishing gradients, an issue wherein size of gradients used during training becomes increasingly small, thereby inhibiting formative learning, and increasing time for training. Additionally, quantum computing system models may also suffer from a problem wherein local minima/maxima are mistakenly categorized as a global minimum/maximum during training.

The present disclosure may relate to, among other things, a scalable training method utilizing data subsets of increasing size to improve the training of parameters of a quantum computing system model by scaling quantum circuit depth and retraining on a quantum computer. Thus, computing processes and performance of the quantum computer may be improved by creating a method and system of more efficiently training quantum computing system models according to the present disclosure.

Additionally or alternatively, the present disclosure relates to, among other things, scaling quantum circuit depth on quantum computing devices during training of quantum computing system models. Quantum computing devices may include a quantum circuit that includes one or more quantum logic gates that create quantum circuit depth. Including a greater number of quantum logic gates (i.e., increasing quantum circuit depth) may improve the computing capabilities of a given quantum computing device by enabling more intricate superposition and entanglement patterns and increased quantum parallelism. For example, increasing quantum circuit depth may allow for the implementation of more complex quantum algorithms on a quantum computing device such as Shor's algorithm, Grover's algorithm, variational quantum algorithms, etc. Increasing quantum circuit depth enables a quantum computing device to explore a larger portion of a solution space simultaneously (quantum parallelism) which may increase quantum computing speed, especially for computations involving quantum algorithms that work by iteratively adjusting parameters to approximate a solution.

Increasing the number of quantum gates may also increase the noise level of results output by the given quantum computing device due to the finite coherence time of qubits. Because quantum computing devices may only include a limited number of qubits on which quantum logic gates may perform operations, there may be few or no available qubits for performance of quantum logic gate error-correction and/or fault-tolerance operations. As such, in some embodiments of the present disclosure, quantum circuit depth in a quantum circuit may be scaled during the training of quantum computing system models based on results of the training. Scaling the quantum circuit depth may assist in reducing a noise level and/or reducing a number of qubits that may be used during the training because deeper quantum circuits have more layers of quantum logic gates to detect and correct errors effectively. In these and other embodiments, scaling the quantum circuit depth may include adjusting a number of quantum logic gates using by the quantum computer. These and other embodiments of the present disclosure may provide improvements over previous iterations of methods of training parameters of quantum computing system models by reducing the computational time to solve problems using quantum computing devices and/or reducing the effects of vanishing gradients on computations, and thus provide more efficient and/or accurate computing results.

Embodiments of the present disclosure are explained with reference to the accompanying figures.

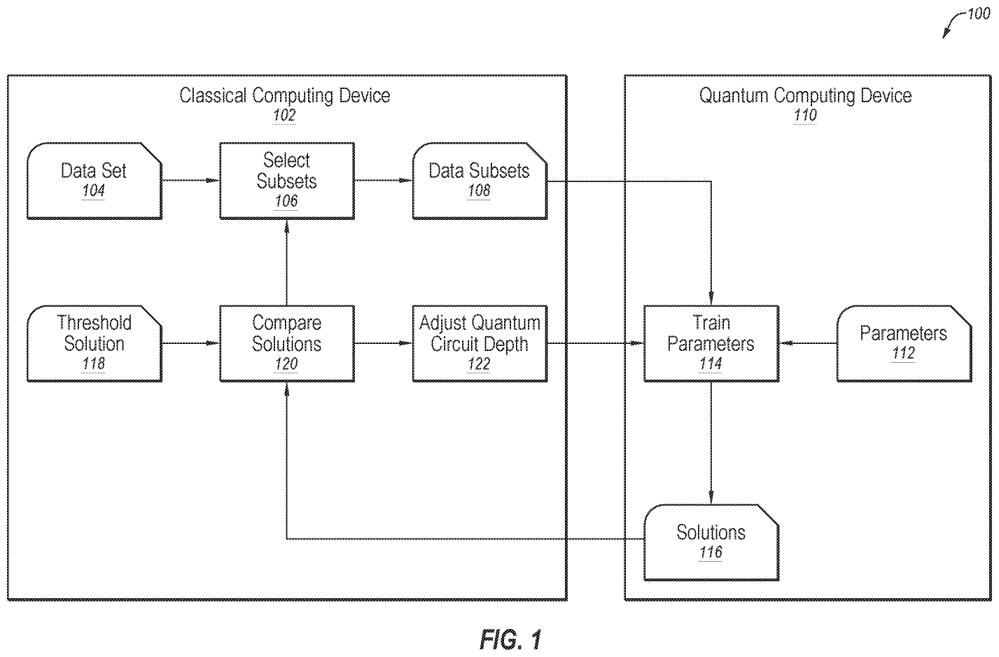

FIG. 1 illustrates an example operating environment 100 for training parameters 112 of a quantum computing system model according to one or more embodiments of the present disclosure. The environment 100 may include a classical computing device 102 and a quantum computing device 110. The classical computing device 102 may include any of various devices in which computing operations can be carried out, such as computer systems or components thereof. For example, the classical computing device 102 may be any computer and/or computing device that uses classic binary bits for operations, wherein a classic binary bit is a bit that includes only two states 1 or 0. Thus, the classical computing device 102 may be any electronic or digital device that includes hardware and programming to utilize at least one classic binary bit for processing and does not use quantum bits or qubits for processing. As used herein, the term classical computing device 102 is not limited to just integrated circuits, but broadly refers to a processor, a server, a microcontroller, a microcomputer, a programmable logic controller (PLC), an application specific integrated circuit, and other programmable circuits. In some embodiments, the classical computing device 102 may include a processor, a memory, a data storage, a communication unit, and/or any other computing modules. For example, the classical computing device 102 may include one or more computers, servers, or other known computing devices as described. Some examples of a classical computing device 102 include a desktop computer, laptop computer, a tablet computer, a server computer such as a rack-mounted server, a mobile phone, a smartphone, a network device, telecommunications equipment, a single board computer (SBC), a system-on-a-chip (SOC), a microcontroller unit (MCU), and any other electronic or digital device with a processor. In some embodiments, the classical computing device 102 may include computer peripherals associated with a user interface such as a computer mouse, a keyboard, and/or a scanner. Furthermore, in some embodiments, the classical computing device 102 may include output channels such as a user interface monitor and/or a printer.

In some embodiments, the quantum computing device 110 comprises a quantum processor, which in turn may comprise at least one qubit, and means for storing the at least one qubit. The at least one qubit may be physically implemented using, for example, photons, trapped ions, electrons, one or more nuclei, superconductor circuits, and/or quantum dots. A qubit may be physically implemented in a variety of ways including the polarization state of a single photon, the spatial optical path of a single photon, two differing energy states of an atom or an ion, and/or the spin orientation of a particle or multiple particles, such as a nucleus. In some embodiments, the quantum processor may comprise at least two qubits and at least one coupler capable of coupling the qubits. Storing the at least one qubit may include maintaining the at least one qubit in a suitable environment to allow quantum computation, for example by supercooling the at least one qubit. The at least one qubit may be operated upon by one or more quantum circuits, formed by a suitable arrangement of quantum logic gates.

For example, the quantum computing device 110 may be a noisy intermediate-scale quantum (NISQ) device, a quantum annealer, an analog quantum computer, a universal quantum computer, and/or any combination of computing devices with at least one qubit.

In some embodiments, the quantum computing device 110 may be communicatively coupled to the classical computing device 102. The classical computing device 102 may provide instructions to, preprocess data for, and interpret results from the quantum computing device 110. For example, the classical computing device 102 may be arranged to instruct the quantum computing device 110 to prepare quantum states and/or to perform measurements on those quantum states, according to instructions stored in memory on the classical computing device 102. In some embodiments, the classical computing device 102 and the quantum computing device 110 may be communicatively coupled through cloud services such as where the classical computing device 102 sends computational tasks to a remote quantum computing device 110 over a network.

The environment 100 may be used for implementing a process of generating a quantum computing system model using the classical computing device 102 and the quantum computing device 110. The quantum computing device 110 may generate the quantum computing system model using data subsets 108 selected using the classical computing device 102 from a set of data sets 104. The quantum computing system model may be used by the quantum computing device 110 to determine patterns or make decisions based on a previously unseen data set. For example, the model may be configured to provide a solution to a combinatorial optimization problem. The quantum computing system model may be generated using one or more quantum algorithms such as a variational quantum algorithm or algorithms used in quantum machine learning techniques. For example, the quantum computing system model may be generated using a quantum approximate optimization algorithm.

In some embodiments, the process of generating a quantum computing system model may include multiple operations, including selecting subsets 106, training parameters 114, comparing solutions 120, and adjusting quantum circuit depth 122. In some embodiments, the process may be an iterative process. As a result, the operations of selecting subsets 106, training parameters 114, comparing solutions 120, and adjusting quantum circuit depth 122 may be performed multiple times to generate the quantum computing system model.

In some embodiments, to begin the process, the classical computing device 102 may obtain a data set 104. The data set 104 may include one or more sets of data that may be used in training parameters 114 of the quantum computing system model. For example, the data set 104 may be a single set of data or multiple sets of data. As an example, the data set 104 may include a compilation of data that may include multiple different data entries and may be arranged in multiple different configurations. In some embodiments, the data set 104 may include information for an undirected graph including nodes and edges that connect the nodes. The nodes may represent different data within the data set 104 and the edges may represent a commonality or connection between the nodes. Alternately or additionally, the data set 104 may be arranged in other configurations. In these and other embodiments, the classical computing device 102 may be configured to generate an undirected graph using the data set 104. For example, the data set 104 may initially include prices of assets, such as stocks, over a time period. An asset-to-asset correlation based on the prices may be determined, thus constituting a data set for a specific time window. The data set 104 could then be a sequence of such data sets. In these and other embodiments, the assets may be the nodes and the edges may represent correlation between pairs of assets and/or represent correlation beyond or below a threshold between pairs of assets.

In some embodiments, the data set 104 may include data from or that represents statistical metrics, lists of members of a social network, genes from genomic sequences, images, atoms in a molecule, Internet of Things (IoT) devices, business and/or financial data, and/or any other type of data. For example, the data set 104 may include data relating to financial investments such as data in a particular stock, on multiple different stocks in an index fund, and/or on goods or services, over a period of time. Alternately or additionally, the data set 104 may include data relating to quantum computing devices such as simulated quantum circuits; quantum hardware characteristics including qubit connectivity, quantum logic gate fidelities, error rates; quantum cryptography protocols; and/or data relating to any other aspect of quantum computers. The data set 104 may be generated by the classical computing device 102, input by a user, downloaded from a network, and/or created by a device such as a sensor, camera, satellite, bioinformatic device, healthcare device, audio device, video device, and/or any combination thereof. In some embodiments, an optimization problem or a combinatorial optimization problem may be desired to be solved for the data set 104. The quantum computing system model generated in the environment 100 may be configured to provide a solution to an optimization problem or a combinatorial optimization problem of the data set 104. For example, the optimization problem may be a maximum independent set problem.

In some embodiments, after obtaining the data set 104, the process may include selecting subsets 106. The selecting subsets 106 operations may be performed by the classical computing device 102 and may include generating one or more data subsets 108 of the data set 104. In some embodiments, generating one or more data subsets 108 of the data set 104 may include selecting one or more portions of the data set 104 and generating the one or more data subsets 108 using the one or more portions of the data set 104. For example, the data set 104 may include multiple sets of data. In these and other embodiments, one of the multiple sets of data may be selected as the portion of the data set 104 and the one or more data subsets 108 may be generated using the one of the sets of data.

In these and other embodiments, the data subsets 108 may each include one or more nodes of the data set 104. For example, each of the data subsets 108 may include one node. Alternately or additionally, each of the data subsets 108 may include multiple nodes and the edges connecting those nodes. Thus, each of the data subsets 108 may include information for a nodal graph that includes nodes selected for the respective data subset.

In some embodiments, the quantum computing system model may be generated using the data subsets 108 as training data in place of the entire data set 104. In these and other embodiments, the data subsets 108 may be used in place of the entire data set 104 because the data set 104 may be too large to be used for training by the quantum computing device 110. For example, the quantum computing device 110 may not have enough qubits to allow for training of the entire data set 104. In these and other embodiments, the data subsets 108 may be sized based on the qubits available in the quantum computing device 110 for training.

Alternately or additionally, training the quantum computing system model using one or more data subsets 108 that are smaller than the entire data set 104 may make the training more efficient. For example, training multiple iterations on sets of small data subsets 108 may take less time and/or generate better results than training using the entire data set 104.

Alternately or additionally, training the quantum computing system model using one or more data subsets 108 that are smaller than the entire set of data sets 104 may assist in overcoming problems associated with particular quantum algorithms used to develop the quantum computing system models generated based on the set of data sets 104. For example, some quantum algorithms may be affected by local minima/maxima traps. In some embodiments, training using one or more data subsets 108 that are smaller data sets than the set of data sets 104 may assist in avoiding the local minima/maxima traps for some quantum algorithms.

In some embodiments, a size of the data subsets 108, e.g., a number of data entries or nodes in each of the data subsets 108, may be 1. Alternately or additionally, the size of the data subsets 108 may be greater than 1. For example, the size of the data subsets 108 may be 2, 3, 4, 5, 6, 7, 8, 12, 15, 20, 25, 30, 50, 75, 100, 150, 200, 250, 500, 750, 1000, 2000, 4000, 7500 or larger. The size of the data subsets 108 may be based on the complexity of the edges between the nodes in the data subsets 108. For example, the size of the data subsets 108 may be selected such that variations in the structure of the sub-graphs formed by the nodes in the data subsets 108 begin to occur. In these and other embodiments, a size of the data subsets 108 may be increased during iterations of a process performed to generate the quantum computing system model.

In some embodiments, the number of data subsets 108 that are selected may be determined by a user and/or by the classical computing device 102. In some embodiments, the number of data subsets 108 selected may be based on available computational resources such as available memory and/or statistical models indicating the number of data subsets 108 to approximate the behaviors of the data set 104 to a specified confidence level.

In some embodiments, the classical computing device 102 may select data subsets 108 by selecting a node (i.e., an initial node) in the data set 104 for each of the data subsets 108. After selecting the initial node for a particular data subset 108, the classical computing device 102 may select one or more other nodes based on the number of nodes in each of the data subsets 108. In some embodiments, the initial node may be selected randomly or based on one or more factors. For example, a user desiring to train a quantum computing system model may select an initial node that is at the center of that particular data subset 108 based on some measure of centrality or local node-based centrality.

In some embodiments, the classical computing device 102 may select the other nodes of the data set 104 randomly or the other nodes may be selected based on neighboring the initial node of the data set 104. In some embodiments, selecting a data subset 108 may include continuing to select one or more neighboring nodes of the initial node until the data subset 108 reaches a number of nodes to include in each of the data subsets 108. In these and other embodiments, a search algorithm may be used to select the neighboring nodes of the initial node.

In these and other embodiments, the search algorithm may be a linear search algorithm, a sentinel linear search algorithm, a binary search algorithm, a meta binary search algorithm, a ternary search algorithm, a jump search algorithm, an interpolation search algorithm, an exponential search algorithm, a Fibonacci search algorithm, a breadth first search algorithm, a depth first search algorithm, Dijkstra's algorithm, the Floyd Warshall algorithm, Prim's algorithm, Kruskal's algorithm, and/or any other algorithm used to determine neighboring nodes.

In some embodiments, the data subsets 108 may be provided to the quantum computing device 110 used for training a quantum computing system model. The data subsets 108 may be provided to the quantum computing device 110 via one or more physical networks, cloud networks, Random Access Memory (RAM) drives, flash memory devices (e.g., solid state memory devices), and/or any other way by which data may be transferred between devices.

In some embodiments, the process of generating the quantum computing system model may include the operation of training parameters 114. The operation of training parameters 114 may be performed by the quantum computing device 110 and may include training and/or adjusting one or more parameters 112 of the quantum computing system model. The parameters 112 of the quantum computing system model may determine how the quantum computing device 110 may function to find a solution to a quantum system algorithm and/or optimization given a data set 104, such as an unseen data set. The functioning of the quantum computing device 110 may include how the quantum computing device 110 uses one or more qubits, measures properties of the one or more qubits in response to performing quantum operations, and/or outputs and/or stores such measured properties. In some embodiments, the parameters 112 may include a quantum circuit depth. In these and other embodiments, the quantum circuit depth may refer to a number of layers of quantum logic gates used to complete a computation on a quantum computing device 110.

In some embodiments, the parameters 112 may be initialized with particular values before training begins. In these and other embodiments, the initialized values may be zero or some other values based on the data set 104. In some embodiments, the quantum circuit depth may be initialized with a value equal to or greater than 1. For example, the quantum circuit depth may be initialized with a value of two indicating that two layers of the quantum circuit may be used during the training.

In some embodiments, the quantum computing device 110 may train the one or more parameters 112 by adjusting the parameters 112 to achieve specific outcomes such as to minimize or maximize an objective function to solve an optimization problem given a data set 104. To train the parameters 112, multiple training iterations may occur. During each training iteration, one of the data subsets 108 may be selected and a particular quantum circuit layer of the quantum circuit may be selected based on the selected quantum circuit depth. For example, with a selected quantum circuit depth of two, one of two layers may be selected. For a selected quantum circuit depth of four, one of four layers may be selected. In these and other embodiments, one of the same four layers may be selected until the quantum circuit depth is adjusted. After adjustment of the quantum circuit depth, the previous layers and the additional layers may be selected from. In some embodiments, the one of the data subsets 108 and the particular quantum circuit layer may be selected randomly.

In some embodiments, training the parameters 112 may include adjusting one or more of the parameters 112, not including the quantum circuit depth, based on an algorithm to solve an optimization problem with respect to the selected one of the data subsets 108 and the particular quantum circuit layer. In these and other embodiments, the parameters 112 to be adjusted may be the parameters for the selected layer of the quantum circuit layers. For example, training the training parameters 112 may include applying a stochastic gradient descent algorithm from which it is determined how to adjust the parameters 112 given the selected one of the data subsets 108 and the particular quantum circuit layer. In these and other embodiments, the parameters 112 may be adjusted during each training iteration that is associated with the selected layer of the quantum circuit layers. Thus, for a first iteration, the parameters 112 may have initial values and may be adjusted to first values. For a second training iteration, the parameters 112 may have the first values and may be adjusted to second values.

After training the parameters 112, a quantum computing system model may be generated using the parameters 112 and the quantum circuit depth. In these and other embodiments, an optimization problem for one or more of the data subsets 108 may be solved by the quantum computing device 110, with the quantum computing device 110 configured according to the quantum computing system model. Thus, the quantum computing device 110 may generate solutions for each of the subsets 108 provided to the quantum computing device 110. For example, in some embodiments, all of the data subsets 108 may be provided to the quantum computing device 110 for solution generation.

The quantum computing device 110 may then provide the solutions to the classical computing device 102 via one or more physical networks, cloud networks, Random Access Memory (RAM) drives, flash memory devices (e.g., solid state memory devices), and/or any other means by which data may be transferred between devices. In some embodiments, the classical computing device 102 may generate a solution that may be a mathematical combination of the solutions 116 for each of the data subsets 108 provided from the quantum computing device 110. The mathematical combination may be a mean, median, weighted mean, or some other mathematical combination of the solutions 116 for each of the subsets 108.

In some embodiments, the classical computing device 102 may be configured to obtain a threshold solution 118 for the data subsets 108. The threshold solution 118 may be based on a computed solution and a threshold quality. For example, the computed solution may be a mathematical combination of actual solutions to an optimization problem being solved by the quantum computing device 110 using the data subsets 108. The computed solution may be based on the same mathematical combination of the solutions from the same data subsets 108. In an initial iteration, the computed solution may be based on the actual solutions for each of the data subsets 108 that may be brute force solved by the classical computing device 102 or provided to the classical computing device 102. The actual solutions may be mathematically combined to obtain the computed solution in a similar manner as to how the solutions 116 may be combined. In subsequent iterations, the computed solution may be approximated by the quantum computing device 102 using parameters 112 that were trained in a previous round of training parameters 114. For example, during a current round of training, the quantum computing device 102 may use the parameters 112 from the previous round of training to generate solutions 116 using the data subsets 108 for the current round of training and may use the solutions 116 to generate the computed solution used to generate the threshold solution 118 for the current round of training.

In some embodiments, the threshold quality may be a value based on how closely the solutions 116 of the quantum computing system model approximate the computed solution. For example, the threshold quality may be a percentage between one and one-hundred, where one-hundred percent may indicate that the solutions 116 are exact solutions and lesser percentages may indicate how close the solution 116 is to an exact solution. For example, a value of ten percent may indicate that the solution 116 is marginally related to the exact solution. In these and other embodiments, the threshold quality may be selected by a user and may be based on a time constraint, resource constraint, and/or user preference.

In some embodiments, the threshold solution 118 may be computed through a mathematical combination of the computed solution and the threshold quality. For example, the computed solution may be an actual solution obtained for an optimization problem brute force solved by the classical computing system 102 for a small data subset 108 and the threshold quality may be a percentage (e.g., 85%) as selected by a user such that the threshold solution 118 may be obtained by multiplying the computed solution by the threshold quality.

In some embodiments, after obtaining the threshold solution 118 and the solution, the process may include the operation of comparing solutions 120. The operation of comparing solutions 120 may be performed by the classical computing device 102. In these and other embodiments, the solution may be compared to the threshold solution 118 to determine if the solution satisfies the threshold solution 118. Satisfaction of the threshold solution 118 by the solution may indicate that the quantum computing system model is determining solutions for the data subsets 108 at an accuracy that is acceptable to a user that selected the threshold solution 118. In these and other embodiments, as a result of the solution satisfying the threshold solution 118, the process may expand the size of the data subsets 108 and continue iterating. This may reduce the likelihood of vanishing gradients by selecting the initial parameters in the subsequent iteration to be the parameters 112 found for the set of smaller sized data subsets 108. For example, the operation of selecting subsets 106 may be performed again. In the next iteration, each of the data subsets 108 may include more nodes for each data subset 108 than in previous data subsets 108. For example, the number of nodes in each of the data subsets 108 may increase by one, two, three, four, five, or some other value. After determining the data subsets 108 with the increased number of nodes, the process may include the operation of training parameters 114. In some embodiments, the values of the parameters 112 may be maintained from the previous operation of training parameters 114. For example, using the parameters 112 from a previous operation to generate the computed solution may help to recognize high-quality minima to help reduce effects related misidentifying poor quality minima as high quality minima. Alternately or additionally, the values of the parameters 112 may be set to other values, such as zero or some derivative of the values of the parameters 112 from previous iterations. In these and other embodiments, the process may continue as discussed above.

In some embodiments, the solution may not satisfy the threshold solution 118. The solution not satisfying the threshold solution 118 may indicate that the quantum computing system model is not determining solutions for the data subsets 108 at an accuracy that is acceptable. In these and other embodiments, the parameters 112 may be further adjusted. To begin, the quantum circuit depth may be adjusted.

In some embodiments, adjusting the quantum circuit depth may include adding to the quantum circuit depth. Adding to the quantum circuit depth may include adding one or more layers to the quantum circuit depth. In these and other embodiments, the layers to be added may be added to the beginning of the existing layers, between the existing layers, or to the end of the existing layers. In some embodiments, the layers to be added may be added in the middle of the existing layers.

In some embodiments, the parameters 112 of the layers recently added may have initialized with values based on the values of parameters 112 in other layers. This may help to overcome vanishing gradients in the training since the initial values are selected from the previous training and those parameters were successful at finding solutions to the set of small data subsets 108 previously considered. Alternately or additionally, the values of the parameters 112 of the layers recently added may be initialized to zero. In these and other embodiments, the parameters 112 of the layers recently added may be trained. For example, a data subset 108 may be randomly selected and one of the layers recently added may be randomly selected and the parameters 112 of the selected layer may be trained in a similar manner as discussed above. The parameters 112 of the layers recently added may be trained over multiple iterations. After training the parameters 112 of the layers recently added, the operation of training parameters 114 may be performed again as discussed previously. In these and other embodiments, the previous and recently added layers of the quantum circuit layers may be randomly selected for a single training iteration.

In some embodiments, during the operation of training parameters 114, the selection of the data subsets 108 may be completely random as discussed above. Alternately or additionally, in some embodiments, some of the data subsets 108 may be weighted. As a result, those data subsets 108 that are weighted more than other data subsets 108 may be selected more often for training the parameters 112. In these and other embodiments, the selection may be pseudo-random. For example, a selection may occur randomly based on the weights applied to the data subsets 108. For example, there may be 500 data subsets 108. A randomly selection would select one of the 500. With a weighted random selection, 100 of the data subsets 108 may be weighted and have two entries such that there are 600 data subsets 108. In a random selection among the 600 data subsets 108, the weighted data subsets may be selected more often.

In some embodiments, the weighting of the data subsets 108 may be based on how well a quantum computing system model based on the parameters is able to solve the problem for the data subsets 108. For example, after multiple iterations a quantum computing system model may be generated using the parameters 112 and the quantum circuit depth. In these and other embodiments, an optimization problem for each of the data subsets 108 may be solved by the quantum computing device 110, with the quantum computing device 110 configured according to the quantum computing system model. Thus, the quantum computing device 110 may generate a solution for each of the data subsets 108. The solution may be compared to a known solution or some previous solution, similar to the operation of compare solutions 120. In these and other embodiments, the data subsets 108 that produce a solution less similar to the known or previous solution as compared to other data subset 108 may be weighted more than other data subsets 108. As a result, the training parameters operation 114 may be trained more often with the poorly performing data subsets 108. Training the parameters 112 more often for poorly performing data subsets may increase the likelihood of the parameters 112 being trained to perform better for the poorly performing data subsets in subsequent iterations.

In some embodiments, the weighting of the data subsets 108 as discussed previously may occur randomly, at specified intervals, or based on other factors during the operation of training parameters 114. For example, if 10,000 training parameters iterations occur, the weighting of the data subsets 108 may occur every 1,000 iterations or randomly during the 10,000 training parameter iterations.

In some embodiments, after the classical computing device 102 performs the operation of comparing solutions 120 and in response to the size of the data subsets 108 being less than the size of the data set 104 and/or the quantum computing device 110 having an available qubit, for example a qubit that is not being utilized, the classical computing device 102 may perform the process of select subsets 106 as described previously.

In some embodiments, after the classical computing device 102 performs the operation of comparing solutions 120 and in response to the size of the data subsets 108 being equal to the size of the data set 104 or the quantum computing device 110 having qubits being utilized, the training of the parameters 112 may conclude and the parameters may be used to generate a quantum computing system model that may be used for unseen data sets.

An example of the operation of the environment 100 is now provided. In this example, the environment 100 may be used to identify low-risk financial investing strategies. The data set 104 may include stock market index tracking data such as data of companies listed on stock exchanges in a country. Within the data set 104, each node may represent a financial asset, and an edge may exist between two nodes if the asset-to-asset correlation is above a specified threshold. The parameters 112 may be trained to solve a minimum optimization problem to identify financial assets with low correlation. As a result, a quantum computing system model may be generated using the parameters 112 that identify financial assets with low correlation based on current trading trends of the financial assets.

Modifications, additions, or omissions may be made to the environment 100 without departing from the scope of the disclosure. For example, the designations of different elements in the manner described is meant to help explain concepts described herein and is not limiting. For instance, in some embodiments, the classical computing device 102 and the quantum computing device 110 are delineated in the specific manner described to help with explaining concepts described herein, but such delineation is not meant to be limiting. Further, the environment 100 may include any number of other elements or may be implemented within other systems or contexts than those described.

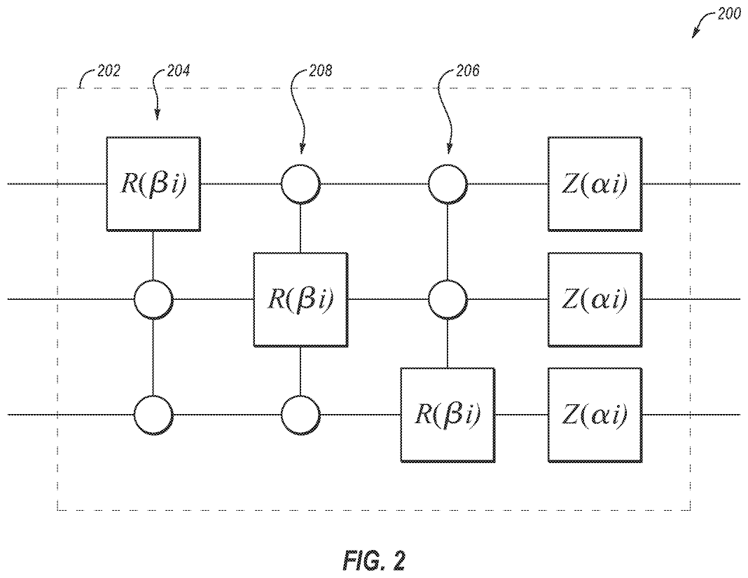

FIG. 2 illustrates an example quantum circuit of a quantum computer according to one or more embodiments of the present disclosure. The quantum circuit 200 may include multiple quantum logic gates 202. For example, the quantum circuit 200 may include one or more CNOT gates, Hadamard gates, Toffoli gates, phase gates, T gates, one or more other quantum logic gates, and/or any combinations of quantum logic gates. The quantum circuit 200 may be implemented in a quantum computing device such as the quantum computing device 110 of FIG. 1.

In some embodiments, the quantum circuit 200 may include multiple quantum logic gates 202 in which each of the quantum logic gates may be configured to perform one or more operations on qubits associated with the quantum circuit 200 and generate a particular output corresponding to a particular input. Similar to classical computing bits, a qubit may have a value of “1” or a value of “0.” Further, a qubit may include a superposition state in which the qubit simultaneously represents a value of 1 and 0 rather than only a value of either 1 or 0 as with classical bits. In some embodiments, where the quantum circuit 200 has multiple quantum logic gates 202, specific quantum logic gates may be designated as a first quantum logic gate 204, a second quantum logic gate 206, etc. In some embodiments, the quantum circuit depth 210 may be adjusted by adding one or more additional quantum logic gates 208 to the quantum circuit 200. For example, the one or more additional quantum logic gates 208 may be placed between the first quantum logic gate 204 and the second quantum logic gate 206. In some embodiments, quantum circuit depth 210 may refer to the number of time steps or layers of quantum logic gates 202 to complete a computation on a quantum computer.

A quantum computing device, such as the quantum computing device 110 of FIG. 1, may include at least one quantum circuit 200 corresponding to the quantum circuit 200 of FIG. 2. In some embodiments, quantum circuit depth of the quantum circuit 200 may be adjusted. Adjusting the quantum circuit depth may include placing one or more quantum logic gates 208 within the quantum circuit 200. In some embodiments, placing the one or more additional quantum logic gates 208 between the first quantum logic gate 204 and the second quantum logic gate 206 may improve quantum entanglement, quantum parallelism, error correction, and/or other characteristic of the quantum circuit 200. In some embodiments, the type of one or more additional quantum logic gates 208 that may be placed may be chosen based on parameters being trained.

Modifications, additions, or omissions may be made to the quantum circuit 200 without departing from the scope of the disclosure. For example, the designations of different elements in the manner described is meant to help explain concepts described herein and is not limiting. For instance, in some embodiments, the plurality of quantum logic gates 202, the first quantum logic gate 204, the second quantum logic gate 206, and the one or more additional quantum logic gates 208 are delineated in the specific manner described to help with explaining concepts described herein but such delineation is not meant to be limiting. Further, the quantum circuit 200 may include any number of other elements or may be implemented within other systems or contexts than those described.

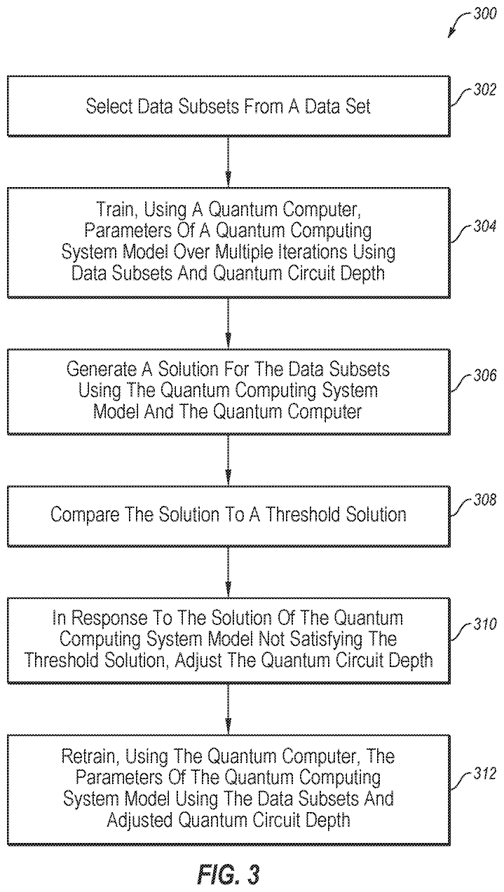

FIG. 3 is a flowchart of an example method 300 of training parameters of a quantum computing system model using a quantum computer according to one or more embodiments of the present disclosure. The method 300 may be performed by any suitable system, apparatus, or device. For example, the classical computing device 102 and/or the quantum computing device 110 may perform one or more of the operations associated with the method 300. Although illustrated with discrete blocks, the steps and operations associated with one or more of the blocks of the method 300 may be divided into additional blocks, combined into fewer blocks, or eliminated, depending on the particular implementation.

The method 300 may begin at block 302, where data subsets may be selected from a data set. In some embodiments, the data set may include interconnected nodes and selecting the data subsets from the data set may include for each of the data subsets selecting a node and applying a search algorithm to select one or more neighboring nodes of the node. In some embodiments, the data subsets may be weighted. In these and other embodiments, the training the parameters may include selecting one of the data subsets based on a weight of each of the data subsets and training the parameters using the one of the plurality of data subsets and the quantum circuit depth. In these and other embodiments, the training may also include adjusting a weight applied to the one of the data subsets based on the training performed using the one of data subsets.

At block 304, multiple parameters of a quantum computing system model may be trained using the data subsets and a quantum circuit depth. The parameters may be trained using a quantum computer over multiple iterations. In some embodiments, training the parameters may include selecting one of the data subsets based on a weight of each of the data subsets, training the parameters using the one of the data subsets and quantum circuit depth, and adjusting the weight applied to the one of the data subsets based on the training performed using the one of the data subsets.

At block 306, a solution for the data subsets may be generated using the quantum computing system model and the quantum computer. In some embodiments, the solutions for each of the data subsets may be mathematically combined by a classical computing device to generate a solution.

At block 308, the solution may be compared to a threshold solution. In some embodiments, comparing solutions may be perform by a classical computing device. In some embodiments, comparing solutions may include determining accuracy of the solutions for the data subsets generated by the quantum computing system model and the quantum computer.

At block 310, in response to the solution of the quantum computing system model not satisfying the threshold solution, the quantum circuit depth may be adjusted. In some embodiments, adjusting the quantum circuit depth may include placing one or more additional quantum logic gates within a quantum circuit of the quantum computer. In these and other embodiments, the quantum circuit may include multiple quantum logic gates. The one or more additional quantum logic gates may be placed between a first quantum logic gate and a second quantum logic gate of the multiple quantum logic gates.

At block 312, the parameters of the quantum computing system model may be retrained on a quantum computer using the data subsets and adjusted quantum circuit depth.

Modifications, additions, or omissions may be made to the method 300 without departing from the scope of the disclosure. For example, the designations of different elements in the manner described is meant to help explain concepts described herein and is not limiting. Further, the method 300 may include any number of other elements or may be implemented within other systems or contexts than those described.

For example, the method 300 may further include selecting multiple second data subsets. In these and other embodiments, each of the multiple second data subsets may be a larger size than the multiple data subsets. The method 300 may further include training, using the quantum computer over the multiple iterations, the multiple parameters of the quantum computing system model using the multiple second data subsets and the quantum circuit depth.

As another example, the method 300 may further include generating a solution to a second data set using the quantum computing system model that was trained. In some embodiments, generating the solution to the second data set may be in response to at least the size of one of data subsets being equal to the size of the data set and all available qubits of the quantum computing being utilized to train the plurality of parameters of the quantum computing system model.

Furthermore, the method 300 may include adjusting the threshold solution based on the solution of the quantum computing system model. For example, the threshold solution may be adjusted to be the average of the minimum that the solutions of the quantum computing system model give to the minimizing optimization problem after a specified number of iterations of training parameters of the quantum computing system model on each data subset.

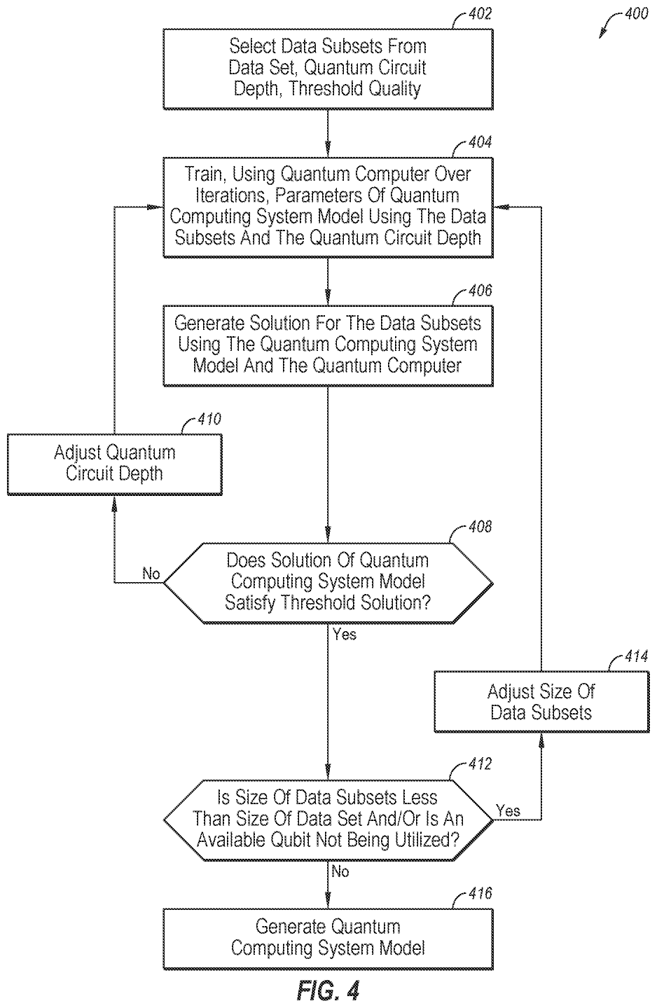

FIG. 4 illustrates a flowchart of an example method 400 for selecting data subsets and training parameters of a quantum computing system model using a quantum computer according to one or more embodiments of the present disclosure.

The method 400 may be performed by any suitable system, apparatus, or device. For example, the classical computing device 102 and/or the quantum computing device 110 may perform one or more of the operations associated with the method 400. Although illustrated with discrete blocks, the steps and operations associated with one or more of the blocks of the method 400 may be divided into additional blocks, combined into fewer blocks, or eliminated, depending on the particular implementation.

The method 400 may begin at block 402, where selection of data subsets from data set, quantum circuit depth, and threshold quality may occur. Selecting data subsets may be random, done by a user, based on preliminary calculations, and/or done in any convenient manner. In some embodiments, selecting data subsets may include selecting a node in the data set at random and applying a search algorithm to locate one or more neighboring nodes until a data subset of a specified size is found. The operation at block 402 may be performed by one or more classical computing devices or may be performed by a quantum computing device.

At block 404, the method 400 may include the operation train, using a quantum computer over iterations, parameters of a quantum computing system model using the data subsets and the quantum circuit depth. In some embodiments, the quantum computer may be the quantum computing device 110 as described in FIG. 1. Each iteration may be performed within an epoch of a specified number of iterations. For example, an epoch may include training over 1,000, 2,000, 4,000, or any number of iterations before the method 400 proceeds from block 404 to block 406. The training may include adjusting parameters of the quantum computing system model such that an objective is achieved. For example, if the quantum computing system model is an optimization problem, the parameters may be adjusted based on the data subsets and the quantum circuit depth until a solution is generated.

At block 406, the method 400 may include the operation generate a solution for the data subsets using the quantum computing system model and the quantum computer. In some embodiments, the solution may be a mathematical combination of solutions for each data subset generated using the quantum computing system model and the quantum computer. For example, the solution may be generated by a classical computing device.

At block 408, it may be determined if a solution of the quantum computing system model satisfies a threshold solution. In some embodiments, the threshold solution may be based on the threshold quality. For example, the threshold quality may be a percentage (e.g., 50%, 65%, 75%, 85%, or any other percentage that may indicate how closely the solution of the quantum computing system model approximates a computed solution) that may be mathematically combined with a computed solution (e.g., through multiplication) to obtain the threshold solution. Satisfying the threshold solution by the solution may indicate that the quantum computing system model is determining solutions for the data subsets at an accuracy that is acceptable. In response to the solution satisfying the threshold solution, the method 400 may proceed to block 412.

At block 410, in response to the solution not satisfying the threshold solution, the method 400 may include adjusting quantum circuit depth. The solution not satisfying the threshold solution may indicate that the quantum computing system model is not determining solutions for the subsets at an accuracy that is acceptable. In these and other embodiments, the parameters may be further adjusted. To begin, the quantum circuit depth may be adjusted. In some embodiments, adjusting the quantum circuit depth may include adding to the quantum circuit depth. Adding to the quantum circuit depth may include adding one or more layers to the quantum circuit depth. In these and other embodiments, the layers to be added may be added to the beginning of the existing layers, between the existing layers, or at to the end of the existing layers. In some embodiments, the layers to be added may be added in the middle of the existing layers.

At block 412, it may be determined if the size of data subsets is less than the size of the data set and/or all available qubits are being utilized. An available qubit may be any qubit not encoded to perform a specific task such as perform a calculation or error-mitigation at a given time. If at block 412 it is determined that the size of data subsets is less than the size of the data set and/or there is an available qubit not being utilized, then the method may proceed to block 414. If at block 412 it is determined that the size of data subsets is determined to be the size of the data set or all available qubits are being utilized then the method may proceed to block 416.

At block 414, the method 400 may include the operation adjust size of data subsets. Adjust size of data subsets may include increasing the number of nodes in each data subset. For example, the data subsets may have a number of nodes n and each of the data subsets may be increased to have a number of nodes n+1. In some embodiments, when the operation of adjust size of data subsets 414 is performed, utilization of available qubits may be altered such that one or more available qubits that was not being utilized is utilized based on the additional node in each of the data subsets.

At block 416, the method 400 may include generating the quantum computing system model using the trained parameters. In some embodiments, the method 400 may further include generating a solution to a second data set using the quantum computing system model.

Modifications, additions, or omissions may be made to the method 400 without departing from the scope of the disclosure. For example, the designations of different elements in the manner described is meant to help explain concepts described herein and is not limiting. Further, the method 400 may include any number of other elements or may be implemented within other systems or contexts than those described.

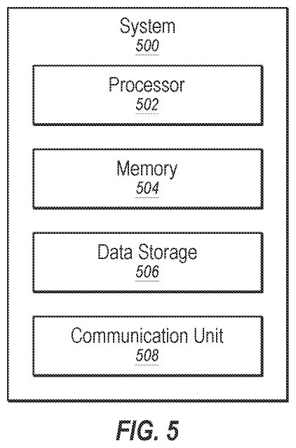

FIG. 5 is an example computing system 500 according to one or more embodiments of the present disclosure. The computing system 500 may include a processor 502, a memory 504, a data storage 506, and/or a communication unit 508, which all may be communicatively coupled. For example, the classical computing device 102 in environment 100 of FIG. 1 may be implemented as a computing system consistent with the computing system 500.

Generally, the processor 502 may include any suitable special-purpose or general-purpose computer, computing entity, or processing device including various computer hardware or software modules and may be configured to execute instructions stored on any applicable computer-readable storage media. For example, the processor 502 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 5, it is understood that the processor 502 may include any number of processors distributed across any number of network or physical locations that are configured to perform individually or collectively any number of operations described in the present disclosure. In some embodiments, the processor 502 may interpret and/or execute program instructions and/or process data stored in the memory 504, the data storage 506, or the memory 504 and the data storage 506. In some embodiments, the processor 502 may fetch program instructions from the data storage 506 and load the program instructions into the memory 504.

After the program instructions are loaded into the memory 504, the processor 502 may execute the program instructions, such as instructions to cause the computing system 500 to perform some of the operations of the method 300 of FIG. 3 and/or the method 400 of FIG. 4. For example, the computing system 500 may execute the program instructions to select data subsets from a data set 302, compare solution of the quantum computing system model to threshold solution 306, and/or adjust quantum circuit depth 308.

The memory 504 and the data storage 506 may include computer-readable storage media or one or more computer-readable storage mediums for having computer-executable instructions or data structures stored thereon. Such computer-readable storage media may be any available media that may be accessed by a general-purpose or special-purpose computer, such as the processor 502. In some embodiments, the computing system 500 may or may not include either of the memory 504 and the data storage 506.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 502 to perform a particular operation or group of operations.

The communication unit 508 may include any component, device, system, or combination thereof that is configured to transmit or receive information over a network. In some embodiments, the communication unit 508 may communicate with other devices at other locations, the same location, or even other components within the same system. For example, the communication unit 508 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 508 may permit data to be exchanged with a network and/or any other devices or systems described in the present disclosure. For example, the communication unit 508 may allow the computing system 500 to communicate with other systems, such as computing devices and/or other networks.

One skilled in the art, after reviewing this disclosure, may recognize that modifications, additions, or omissions may be made to the computing system 500 without departing from the scope of the present disclosure. For example, the computing system 500 may include more or fewer components than those explicitly illustrated and described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and processes described herein are generally described as being implemented in software (stored on and/or executed by general purpose hardware), specific hardware implementations or a combination of software and specific hardware implementations are also possible and contemplated.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method, comprising:
selecting a plurality of data subsets from a data set;
training, using a quantum computer over a plurality of iterations, a plurality of parameters of a quantum computing system model using the plurality of data subsets and a quantum circuit depth;
generating a solution for the plurality of data subsets using the quantum computing system model and the quantum computer;
comparing the solution to a threshold solution;
in response to the solution of the quantum computing system model not satisfying the threshold solution, adjusting the quantum circuit depth; and
retraining, using the quantum computer, the plurality of parameters of the quantum computing system model using the plurality of data subsets and adjusted quantum circuit depth.

2. The method of claim 1, further comprising:
selecting a plurality of second data subsets, wherein each of the plurality of second data subsets is a larger size than each of the plurality of data subsets; and
training, using the quantum computer over the plurality of iterations, the plurality of parameters of the quantum computing system model using the plurality of second data subsets and the quantum circuit depth.

3. The method of claim 2, wherein the plurality of second data subsets are selected in response to a size of one of the plurality of data subsets being less than a size of the data set and all available qubits of the quantum computer not being utilized to train the plurality of parameters of the quantum computing system model.

4. The method of claim 3, further comprising:
generating a solution to a second data set using the quantum computing system model that was trained, wherein the generating the solution to the second data set is in response to at least one of:
the size of one of the plurality of data subsets being equal to the size of the data set; and
all available qubits of the quantum computer being utilized to train the plurality of parameters of the quantum computing system model.

5. The method of claim 1, wherein the data set includes a plurality of interconnected nodes and selecting the plurality of data subsets from the data set includes:
for each of the plurality of data subsets:
selecting a node; and
applying a search algorithm to select one or more neighboring nodes of the node.

6. The method of claim 1, wherein adjusting the quantum circuit depth comprises placing one or more additional quantum logic gates within a quantum circuit of the quantum computer.

7. The method of claim 6, wherein the quantum circuit comprises a plurality of quantum logic gates and the one or more additional quantum logic gates are placed between a first quantum logic gate and a second quantum logic gate of the plurality of quantum logic gates.

8. The method of claim 1, wherein each of the plurality of data subsets are weighted and the training the plurality of parameters includes:
selecting one of the plurality of data subsets based on a weight of each of the plurality of data subsets;
training the plurality of parameters using the one of the plurality of data subsets and the quantum circuit depth; and
adjusting a weight applied to the one of the plurality of data subsets based on the training performed using the one of the plurality of data subsets.

9. The method of claim 1, further comprising:
adjusting the threshold solution based on the solution of the quantum computing system model.

10. The method of claim 1, further comprising:
using the quantum computing system model that was trained using the plurality of parameters and the adjusted quantum circuit depth to generate a solution based on a second data set.

11. One or more non-transitory computer-readable storage media configured to store instructions that, in response to being executed, cause a system to perform operations of claim 1.

12. A system comprising:
a quantum computing device configured to train a plurality of parameters of a quantum computing system model over a plurality of iterations using a plurality of data subsets and a quantum circuit depth; and
a classical computing device communicatively coupled to the quantum computing device, the classical computing device configured to:
select the plurality of data subsets from a data set;
generate a solution for the plurality of data subsets using the quantum computing system model and the quantum computing device;
compare the solution to a threshold solution; and
in response to the solution of the quantum computing system model not satisfying the threshold solution, adjust the quantum circuit depth, wherein after adjusting the quantum circuit depth, the quantum computing device retrains the plurality of parameters of the quantum computing system model using the plurality of data subsets and adjusted quantum circuit depth.

13. The system of claim 12, wherein
the classical computing device is further configured to select a plurality of second data subsets, wherein each of the plurality of second data subsets is a larger size than the plurality of data subsets; and
the quantum computing device is further configured to train, over the plurality of iterations, the plurality of parameters of the quantum computing system model using the plurality of second data subsets and the quantum circuit depth.

14. The system of claim 13, wherein the plurality of second data subsets are selected in response to a size of one of the plurality of data subsets being less than a size of the data set and all available qubits of the quantum computing device not being utilized to train the plurality of parameters of the quantum computing system model.

15. The system of claim 14, wherein
the classical computing device is further configured to generate a solution to a second data set, using the quantum computing system model that was trained, in response to at least one of:
the size of one of the plurality of data subsets being equal to the size of the data set; and
all available qubits of the quantum computing device being utilized to train the plurality of parameters of the quantum computing system model.

16. The system of claim 12, wherein the data set includes a plurality of interconnected nodes and the classical computing device is configured to select the plurality of data subsets from the data set for each of the plurality of data subsets by:
selecting a node; and
applying a search algorithm to select one or more neighboring nodes of the node.

17. The system of claim 12, wherein adjusting the quantum circuit depth comprises placing one or more additional quantum logic gates within a quantum circuit of the quantum computing device.

18. The system of claim 17, wherein the quantum circuit comprises a plurality of quantum logic gates and the one or more additional quantum logic gates are placed between a first quantum logic gate and a second quantum logic gate of the plurality of quantum logic gates.

19. The system of claim 12, wherein each of the plurality of data subsets are weighted and the training the plurality of parameters includes:
selecting one of the plurality of data subsets based on a weight of each of the plurality of data subsets;
training the plurality of parameters using the one of the plurality of data subsets and the quantum circuit depth; and
adjusting a weight applied to the one of the plurality of data subsets based on the training performed using the one of the plurality of data subsets.

20. The system of claim 12, wherein the classical computing device is further configured to use the quantum computing system model that was trained using the plurality of parameters and the adjusted quantum circuit depth to generate a solution based on a second data set.
